(19) United States
(12) Patent Application Publication
(10) Pub. No.: US 2026/0246711 A1
(43) Pub. Date: Aug. 20, 2026

(54) METHOD AND SYSTEM FOR DISTRIBUTED/LAYERED ARTIFICIAL INTELLIGENCE (AI) IN A MOBILITY NETWORK

(71) Applicant: AT&T Mobility ll LLC, Atlanta, GA (US)

(72) Inventors: Effendi Jubilee, Gaithersburg, MD (US); Ming-Ju Ho, Alpharetta, GA (US)

(73) Assignee: AT&T Mobility ll LLC, Atlanta, GA (US)

(21) Appl. No.: 19/058,265

(22) Filed: Feb. 20, 2025

(51) Int. Cl. H04L 41/16; H04W 24/02

(52) U.S. Cl. CPC H04L 41/16; H04W 24/02

(57) ABSTRACT

Aspects of the subject disclosure may include, for example, a system, including an operator-based AI platform including a first AI model implemented in a mobility core, and a plurality of AI agents including respective second AI models that are implemented in corresponding APs of an access network, where one or more of the corresponding APs serve UEs that are within a coverage range thereof, where the UEs include respective AI clients, and where the operator-based AI platform is configured to orchestrate delivery of AI-based content to the plurality of AI agents, the respective AI clients, or a combination thereof based on one or more factors. Other embodiments are disclosed.

### FIELD OF THE DISCLOSURE

The subject disclosure relates to methods and systems for distributed/layered artificial intelligence (AI) in a mobility network.

### BACKGROUND

The rapid evolution of mobile technology has ushered in a new era of high-demand applications that require extensive data transmission across networks. The introduction of advanced user equipment (UE) applications exemplifies this trend. These applications enable users to interact with cloud-based, generative artificial intelligence (AI) systems, including the ability to submit photos or videos for analysis and content generation purposes, which has substantially increased uplink traffic in telecommunication networks. Certain applications, such as navigation and retail shopping platforms, also enable users to submit high resolution data over the network—e.g., allowing users to virtually try on sunglasses, clothing, or even tattoos using generative AI video. These functionalities are increasingly being integrated into AI assistants, where the UE's camera is merged with real-time activities in the real world, which has also resulted in an uptick in uplink traffic. Overall, high-demand applications have and will continue to place significant stress on the network's processing capabilities, speed, link capacity, and latency. This challenge is particularly acute in mobile networks, where air interface capacity and performance are constrained by the available frequencies and bandwidth.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A illustrates an example system/network in which AI functionality is distributed or decentralized across various layers of entities of a mobile network, in accordance with various aspects described herein.

FIG. 2B depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of a decentralized/layered AI architecture in which generative AI functions, agents, modules, and/or clients are distributed across the mobility network core, cell sites, and UEs. As described in more detail below, an operator-based AI system (or platform) may orchestrate the delivery of AI-related content to the various layers of AI entities, such as AI agents in access network devices and AI clients in UEs. Such delivery may be dynamic and tailored or personalized based on network conditions, location or locality, and/or user profiles or personality data.

Decentralizing the AI architecture such that AI tasks are distributed across different layers of AI processors advantageously balances or spreads AI-related processing loads and thus reduces the possibility of extensive data transmissions and network congestion. Proactive and intelligent content pushing or distribution, as described herein, enhances network performance and also improves user satisfaction as well as lowers operating costs. Alleviating network congestion, particularly the air interface link capacity and backhaul capacity, by reducing the need to transmit large amounts of data to a central AI server/system for generative AI processing, also mitigates the impact to the uplink. Personalization of AI-based content delivery based on user profiles, personality data, and/or the like advantageously improves user experiences, especially for premium users, as much of the processing or analysis can be processed at layers that are more local or nearer to the UEs.

In various embodiments, one or more AI agents in the distributed AI architecture may be configured to facilitate (e.g., efficient) content delivery using one or more intelligent beamforming techniques (e.g., relating to azimuth/elevation angles of beams) and/or intelligent scheduling techniques, such as one or more of those described in co-pending U.S. patent application Ser. No. 18/743,632, entitled “LEVERAGING GENERATIVE-ARTIFICIAL INTELLIGENCE (AI) FOR INTELLIGENT RESOURCE SHARING/EXCHANGE” and filed on Jun. 14, 2024 (which is incorporated by reference herein in its entirety). In these embodiments, cell site antennas/transceivers, or more generally, AI-assisted antenna/radio modules, can be supported by the AI agent to effect the various content deliveries such that content is broadcast or transmitted over dedicated channel(s) at the appropriate times and to the appropriate UEs.

One or more aspects of the subject disclosure include a system. The system may include an operator-based AI platform including a first AI model implemented in a mobility core. Further, the system can include a plurality of AI agents including respective second AI models that are implemented in corresponding APs of an access network, wherein one or more of the corresponding APs serve UEs that are within a coverage range thereof, wherein the UEs include respective AI clients, and wherein the operator-based AI platform is configured to orchestrate delivery of AI-based content to the plurality of AI agents, the respective AI clients, or a combination thereof based on one or more factors.

One or more aspects of the subject disclosure include a non-transitory machine-readable medium, comprising executable instructions that, when executed by a processing system including a processor, facilitate performance of operations. The operations can include predicting that an AI client of a UE will submit a user-initiated AI-based request. Further, the operations can include based on the predicting, causing an AI agent of an AP of an access network that is associated with the UE to obtain particular AI-based content that corresponds to the user-initiated AI-based request and to provide the particular AI-based content to the AI client in anticipation of the user-initiated AI-based request.

One or more aspects of the subject disclosure include a method. The method can include predicting, by a processing system including a processor, that an AI client of a UE will submit a user-initiated AI-based request over a communication network that is operated by a first provider to an external AI system that is operated by a second provider. Further, the method can include based on the predicting, causing, by the processing system, an AI agent of an AP of an access network that is associated with the UE to obtain particular AI-based content that corresponds to the user-initiated AI-based request and to provide the particular AI-based content to the AI client in anticipation of the user-initiated AI-based request, thereby reducing network traffic in an uplink of the communication network.

Other embodiments are described in the subject disclosure.

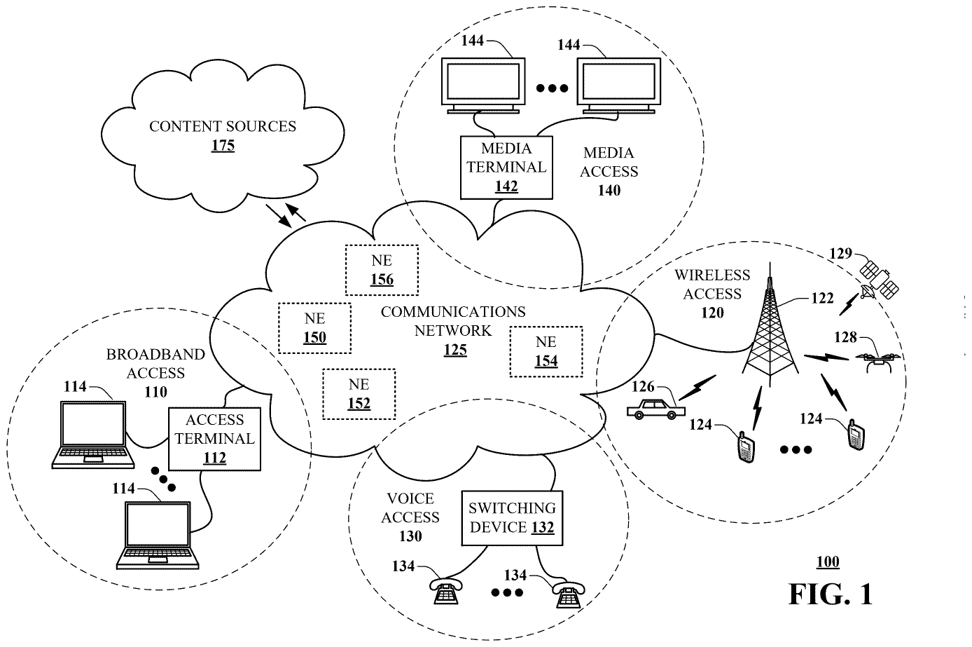

Referring now to FIG. 1, a block diagram is shown illustrating an example, non-limiting embodiment of a system 100 in accordance with various aspects described herein. For example, system 100 can facilitate, in whole or in part, dynamic delivery of AI-related content to AI agents/clients over a network. In particular, a communications network 125 is presented for providing broadband access 110 to a plurality of data terminals 114 via access terminal 112, wireless access 120 to a plurality of mobile devices 124, vehicle 126, and uncrewed aerial vehicle (UAV) 128 via base station or access point 122 (and/or via satellite(s) 129), voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite(s) 129 can be configured for bi-directional communication with one or more access points, with one or more base stations, and/or with one or more mobile devices (e.g., direct-to-cell). In various embodiments, the satellite(s) 129 can include one or more Low Earth Orbit (LEO) satellites or one or more Geostationary Orbit (GEO) satellites.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

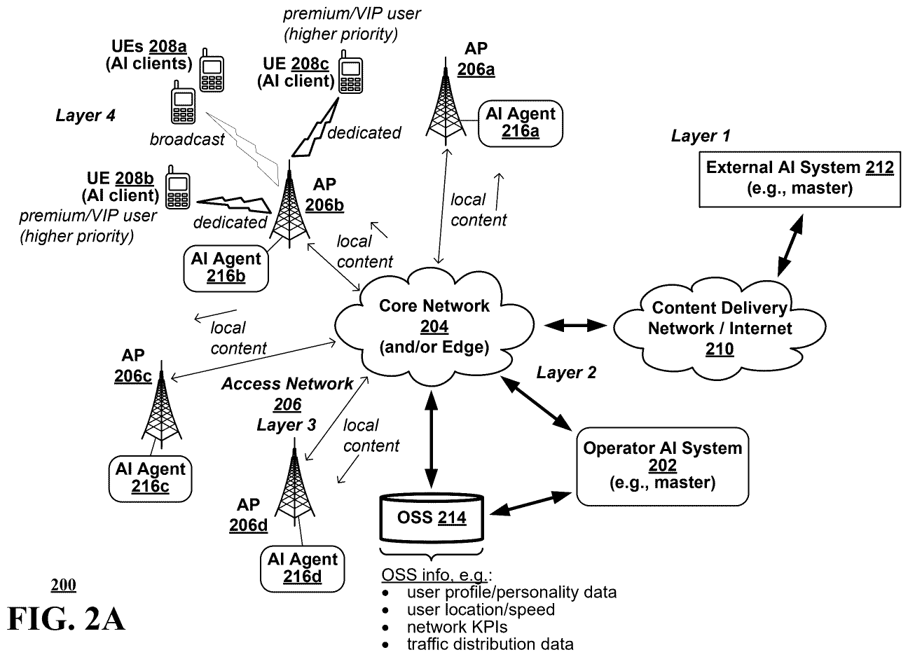

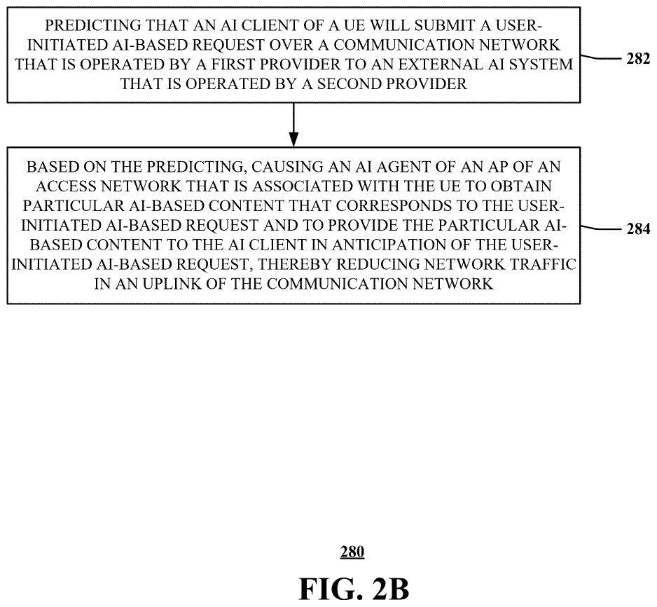

FIG. 2A illustrates an example system/network 200 in which AI functionality is distributed or decentralized across various layers of entities of a mobile network, in accordance with various aspects described herein. In one or more embodiments, the network 200 may function within, or may be operatively overlaid upon, the communications network of FIG. 1. The network 200 may include an operator-based AI system 202, a core (and/or edge) network 204, an access network 206, a content delivery network (CDN)/Internet 210, an external AI system 212, an Operations Support System (OSS) 214, and various UEs—i.e., UEs 208a through 208c and/or one or more additional UEs (not shown).

The core network 204 may include network devices and/or systems that provide a variety of functions. In certain embodiments, the core network 204 may be implemented in a cloud architecture. Examples of functions provided by, or included, in a core network 204 include an access mobility function (AMF) configured to facilitate mobility management in a control plane of the network system (including, for instance, providing user equipment (UE) mobility information associated with one or more access networks (e.g., radio access networks (RANs)) and/or UEs to the core network 204), a user plane function (UPF) configured to provide access to a data network, such as a packet data network (PDN), in a user (or data) plane of the network system, a Unified Data Management (UDM) function, a Session Management Function (SMF), a policy control function (PCF), and/or the like. The core network 204 may be in communication with one or more other networks (e.g., one or more content delivery networks (CDNs), such as the CDN/Internet 210), one or more services, and/or one or more other devices. In one or more embodiments, the core network 204 may include one or more devices implementing other functions, such as a master user database server device for network access management, a PDN gateway server device for facilitating access to a PDN, and/or the like. The core network 204 may include various physical/virtual resources, including server devices, virtual environments, databases, and so on.

The access network 206 may include a wireless RAN, a Wi-Fi network, and/or a wireline network, and may include network resources, such as one or more physical access resources and/or one or more virtual access resources. Physical access resources can include access points (APs) or base station(s) (e.g., one or more eNodeBs, one or more gNodeBs, or the like), one or more satellites, one or more Gigabyte Passive Optical Networks (GPONs) or related components (e.g., Optical Line Terminal(s) (OLT), Optical Network Unit(s) (ONU), etc.), and/or the like. For instance, four APs or sites 206a through 206d are illustrated in FIG. 2A, although it is to be understood and appreciated that the access network 206 may include more or fewer APs or sites. An AP or base station may employ any suitable radio access technology (RAT), such as 4G/LTE, 5G, 6G, or any higher generation RAT. One or more edge computing devices (e.g., multi-access edge computing (MEC) devices or the like) may also be included in or associated with the access network 206. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network 206 may include any number/types of physical/virtual access resources and various types of heterogeneous cell configurations with various quantities of cells and/or types of cells. In certain embodiments, the access network 206 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller.

The core network 204 and the access network 206 may serve UEs 208a through 208c whose users may be subscribers of operator(s) of those networks. A UE may be any computing device that is capable of obtaining and/or processing data and communicating information with one or more other devices (e.g., over the network 200). As some non-limiting examples, a UE may be a communication device (e.g., a router, a modem, a mobile phone, or a wearable device, such as a smart wristwatch, a pair of smart eyeglasses, media-related gear (e.g., augmented reality (AR), virtual reality (VR), or mixed reality (MR) glasses and/or headset/headphones)), a biometric sensor (e.g., for monitoring heart rate, blood pressure, pulse, breathing, etc.), an electrical switch controller, a security camera, an automated assistant, a smart TV, an environmental sensor/controller (e.g., for lighting, temperature, audio, etc.), a kitchen/bath appliance controller (e.g., for a stove, a dehumidifier, etc.), a drapery (e.g., curtain, shade, blinds, or the like) controller, a door/lock controller (e.g., for a room door, a garage door, etc.), a tracking device (e.g., for tracking objects on the road, in a factory/warehouse setting, etc.), a vehicle, a similar type of device, a different type of device, or a combination of some or all of these devices.

The OSS 214 may provide essential information and support for managing/improving/optimizing the mobility network's operations. The OSS 214 may be configured to collect and process data relating to user profiles, personality data, user locations, network key performance indicators (KPIs), and/or traffic distribution. Such information may be used to ensure efficient network performance and to enhance user experience by enabling the network to make informed decisions about content distribution and resource allocation. The OSS 214 may work in conjunction with the operator-based AI system 202 and/or other network components to facilitate the intelligent distribution of content across the network.

In exemplary embodiments, AI functionality may be distributed across various “layers” of the overall system 200. The AI functionality may include the external AI system 212 in one layer (e.g., Layer 1), the operator-based AI system 202 in another layer (e.g., Layer 2), AI agents 216a through 216d in the APs 206a through 206d in yet another layer (e.g., Layer 3), and AI clients in the UEs 208a through 208c in a further layer (e.g., Layer 4).

The external AI system 212 may include one or more AI processors that operate outside of the mobility network. The external AI system 212 may be operated by a third party, may be implemented in a cloud infrastructure, and may interface with the mobility network, particularly the core network 204, via the CDN/Internet 210. The external AI system 212 may be configured to handle AI-related tasks including analyzing vast datasets and executing complex algorithms. For instance, the external AI system 212 may include one or more large language models (LLMs), one or more transformer-based model(s), one or more auto-regressive models, one or more of another type of generative AI model, or a combination of some or all of these models. The external AI system 212 may receive AI-related requests from the AI clients, the AI agents, and/or the operator-based AI system 202, and may respond to the requests with AI generated data. Although a single external AI system 212 is illustrated, it will be understood and appreciated that there may be numerous such systems provided by numerous AI system providers.

The operator-based AI system 202 may be configured to orchestrate dynamic AI-related content delivery to lower layers, particularly the AI agents (e.g., Layer 3) and/or the AI clients (e.g., Layer 4). The operator-based AI system 202 may analyze user data and/or network conditions, may predict user needs and the appropriate content to deliver based on the analysis, and may preemptively cause relevant AI-generated information to be delivered in accordance with the predictions (e.g., before the user requests, or without users requesting, such information). The operator-based AI system 202 may include one or more LLMs, one or more transformer-based model(s), one or more auto-regressive models, one or more of another type of generative AI model, or a combination of some or all of these models.

The operator-based AI system 202 may be implemented in any suitable portion of the mobility network. As an example, the operator-based AI system 202 may be implemented in the core network 204. As another example, the operator-based AI system 202 may be implemented in an edge portion of the mobility network or in one or more RAN intelligent controllers (RICs) or a system that interfaces RICs. Although not shown, a RIC may include a first RIC portion implemented, or otherwise incorporated, in a network service management platform. The RIC may include a second RIC portion having a control or centralized unit (CU) (e.g., a base station CU, such as a gNodeB (gNB) CU or the like) that provides a CU applications layer as well as a CU control plane (CU-CP) and a CU user plane (CU-UP). In various embodiments, the first RIC portion may be configured to operate in non-real-time, and the second RIC portion may be configured to operate in near real-time. The particular functions performed by the two RIC portions can vary based on various criteria, including implementing changing parameters or requirements for the network, and can also include redundancy and/or dynamic switching of functions between the RIC portions. In various embodiments, the CU may interact with distributed units (DUs) that implement baseband units. In exemplary embodiments, each of one or more DUs may be implemented as a virtual DU (vDU). The DUs may respectively interact with remote radio heads or remote units (RUs). The RUs, the DUs, and the CU may, by way of fronthaul(s), midhaul(s), and backhaul(s), provide (e.g., controlled) connectivity between the core network 204 and the UEs 208a through 208c. In various embodiments, the access network 206, including some or all of its components, may conform to open standards, such as O-RAN standards or the like.

The AI agents in the APs 206a through 206d may include processing units that are capable of executing AI algorithms. An AI agent may be configured to interact with the operator-based AI system 202, request data and obtain data from the external AI system 212 (e.g., based on instructions from the operator-based AI system 202 and/or AI clients), store obtained data locally, and/or prepare the data for delivery to select UEs.

The AI clients in the UEs 208a through 208c may include software modules that facilitate user interaction and data processing relating to generative AI. An AI client may provide a user interface for users to input queries, and may communicate with AI agents to obtain necessary data. An AI client may directly interact with the external AI system 212 to access AI-generated information or AI-related services.

In one or more embodiments, the operator-based AI system 202 may include one or more generative AI models that have access to and/or that are trained on a vast array of information relating to the overall network. These generative AI model(s) may, based on such access/training, facilitate or provide for dynamic decision-making on whether, when, and/or how to dynamically deliver content to AI agents and/or AI clients. As an example, the generative AI model(s) may have access to real-time data on network topology, performance metrics, and/or radio resource management. Some or all of this data may be obtained from the OSS 214. For instance, the generative AI model(s) may be aware of the current network load (e.g., averaging around 80%) where a peak load (e.g., 95%+) was reached during rush hour yesterday. The generative AI model(s) may have access to historical data to know that this trend has held steady over the past quarter, with minor fluctuations due to changes in user behavior and service usage patterns. Historical network performance metrics may include average latency, peak latency, average throughput, peak throughput, and so on. The generative AI model(s) may have access to information relating to radio bearer utilization (e.g., currently at an average of 70% capacity, with peaks reaching as high as 90%), which the generative AI model(s) may use to predict upcoming network load and make proactive decisions about content delivery scheduling. In terms of quality-of-service (QoS) metrics, the generative AI model(s) may have access to information relating to latency, transmission speed, transmission frequency, data throughput, routing, uplink/downlink, quality of service class identifiers (QCIs), voice quality, video quality, and/or the like, and may use such information to determine whether metrics have been relatively stable or if there are signs of strain during peak hours.

In one or more embodiments, the operator-based AI system 202 may be configured to pre-emptively push content, or cause content to be delivered, to lower layers—i.e., to the AI agents and/or the AI clients. For instance, subset(s) of local information may be pushed to AI clients that are within a coverage area of a given AP/AI agent. The content may include information that is associated with a region associated with the AI agents and/or the AI clients. For example, the content may be unique or specific to local markets, sub-markets, counties, clusters, or individual sites. The content may relate to local events or news (e.g., accidents, weather conditions, traffic conditions, etc.). The content may relate to local attractions (e.g., a popular museum or park), advertisements (e.g., promotions from nearby stores), user browsing interests (e.g., trending topics in the area), analytics relating to user searches (e.g., common search queries in the region), user interests (e.g., popular hobbies or activities), events (e.g., a concert or sports game), and/or the like. For instance, if a local sports event is happening, the operator-based AI system 202 may obtain AI-generated information about the event, such as AI-generated text information, images, or audio/video samples relating to the event. Upon detecting (e.g., based on data obtained from the OSS 214) that the UE 208c is approaching or is within a threshold distance from the AP 206b, and in anticipation of the user possibly capturing a picture of the stadium and inquiring about the event, the operator-based AI system 202 may preemptively send the AI-generated information to the AI agent of the AP 206b. The AI agent may then monitor for requests, such as an image taken and submitted by the user of the UE 208c via the AI client, and may respond to the UE 208c with the AI-generated information.

In certain embodiments, the operator-based AI system 202 may orchestrate distribution of content by tailoring or adjusting the amount of content and/or a frequency of delivery of content/updated content based on a variety of factors. Examples of such factors include the locality (i.e., select AI agents) involved, network traffic conditions (e.g., whether it is during peak hours, in which case the operator-based AI system 202 may avoid causing content to be distributed), UE-related profile data (e.g., user profile data, where content determined to likely be of interest to a user may be pre-emptively delivered to the AI client of a corresponding UE), UE mobility/location data (e.g., UE location/speed, where content may be delivered at a faster rate or using dedicated resources, such as a dedicated channel, to a UE that is determined to be moving faster than a threshold speed than to one that is moving slower than the threshold speed), user priority, and/or the like.

In some embodiments, UEs or associated subscribers may be assigned a priority level, such as low or high. The operator-based AI system 202 may utilize this priority information to configure different communication channels for AI-generated content deliveries to the UEs. For UEs that are assigned a low priority, the operator-based AI system 202 may configure and utilize a lower bandwidth, broadcast channel to serve these UEs simultaneously. Conversely, for high-priority UEs, such as VIP or premium subscribers, the operator-based AI system 202 may establish and utilize higher bandwidth, dedicated channels to serve these UEs so as to ensure optimal service quality for high-priority users.

In some embodiments, the operator-based AI system 202 may obtain network operator-specific content. For example, the network operator might wish to promote a discount or a special offer to subscribers in a particular area. This operator-specific content may include information about sales events, new product launches, or exclusive deals that are available to subscribers. The operator-based AI system 202 may gather this content from a system that is populated with such promotional information, and may dynamically push the information to AI agents for condition-based delivery to AI clients. For instance, the operator-based AI system 202 may, utilize one or more AI models to predict, based on historical network conditions, whether there will likely be a high concentration of users near a shopping district (e.g., a number of UEs that will exceed a first threshold number and that will all be within a threshold distance from a particular location) within a threshold time from a current time. If so, the operator-based AI system 202 may push promotional content relating to certain stores in the shopping district to the AI agents, which can then pre-emptively deliver such content to the AI clients of UEs.

In various embodiments, the operator-based AI system 202 may cause updated content to be distributed to AI agent(s) and/or AI client(s). The operator-based AI system 202 may trigger the updated content deliveries periodically or based on one or more conditions being satisfied. For instance, the condition(s) may relate to network capacity, such as when traffic over a portion of the network associated with a given AI agent or AI client falls to or below a threshold level. The condition(s) may additionally, or alternatively, relate to specific time windows, such as during maintenance windows. The condition(s) may additionally, or alternatively, relate to the content itself, such as changes or updates to portion(s) of the content.

The operator-based AI system 202 may tailor AI-generated content itself based on user profile data, such as user search history, activity information, and/or user personality information. For instance, a given user's activities may suggest a preference for certain types of content, such as sports or entertainment, in which case the operator-based AI system 202 may cause AI-generated information about upcoming concerts or sports games to be delivered to the user's AI client. Similarly, if a user's personality profile suggests a preference for educational content, the operator-based AI system 202 may cause AI-generated articles or videos relating to recent scientific discoveries or historical events to be delivered to the user's AI client. This personalized approach ensures that users receive content that aligns with their interests and preferences.

The AI clients may communicate with AI agents to access AI services. For example, an AI client may initiate a request for a generative AI task to a corresponding AI agent. For example, a user may perform an action, such as using a UE to capture a photo and asking via an AI client for information about an object in the image. The AI agent may act as an intermediary and may funnel or transmit the request to the operator-based AI system 202. The operator-based AI system 202 may serve as a central processing hub that funnels or transmits the request to the external AI system 212 to perform the generative AI task. The generative AI response from the external AI system 212 may then be provided to the operator-based AI system 202, for further transmission to the AI agent and ultimately to the AI client.

In one or more embodiments, one or more (e.g., each) layer of the network may possess generative AI capabilities. AI agents, in particular, may have the ability to intercept requests from AI clients and process them directly. An AI agent may determine if it is capable of handling a request. This may include determining whether the AI agent has previously obtained relevant content from the operator-based AI system 202 or the external AI system 212. Where the AI agent determines that it is capable of responding, the AI agent may respond directly to the AI client. This advantageously reduces the need to pass requests to the core network 204, thereby reducing network traffic and improving overall network performance.

In certain embodiments, the operator-based AI system 202 may also have generative AI capabilities. If an AI agent determines that it is not capable of handling a request, the AI agent may consult the operator-based AI system 202. The operator-based AI system 202 may then assess its own capabilities to determine whether it can handle the request, which again may include determining if the operator-based AI system 202 already has relevant information available to use in the response. Where the operator-based AI system 202 determines that it is capable of responding, the operator-based AI system 202 may generate the response, and transmit it to the AI agent for forwarding to the AI client. Otherwise, the operator-based AI system 202 may transmit the request to the external AI system 212 for generative AI processing.

In one or more embodiments, AI agents may proactively send information to UEs. For instance, if the AI agent detects a high search demand relating to a local landmark (e.g., greater than a threshold number of AI clients have submitted AI-related search requests associated with the local landmark), the AI agent may utilize its generative AI model(s) to generate data regarding the local landmark. Or, the operator-based AI system 202 may detect the high search demand and instruct the AI agent to generate the data regarding the local landmark. When a given UE enters coverage area of the AI agent (e.g., establishes a connection with the corresponding AP or is determined to be within a threshold distance from the AP), the AI agent may (e.g., automatically or based on network conditions, such as network traffic falling below a threshold) send the pre-generated data to the UE's AI client. The AI client can store this data in memory for later retrieval. For example, if the user initiates a search using the AI client, the AI client can quickly access its memory to provide relevant information as an immediate response. Additionally, the AI client may automatically trigger a notification (e.g., based on the user having enabled such settings in the AI client) or present the information on the user's device without the user having to specifically submit a request.

In another example, if a user trend indicates a search for specific content, the operator-based AI system 202 or an AI agent may anticipate the user's search at a particular time, such as 8 AM. The operator-based AI system 202 may prepare or generate the content via AI model(s) (e.g., with or without the aid of the external AI system 212), and may push the AI-generated content to the AI agent. The AI agent, now equipped with the content, may automatically send the content to the AI client of the user's UE without the user having to request it.

In some embodiments, users may have the option to pre-select which generative AI model they would prefer to be used to generate AI-related content. For instance, a user might choose the operator-based AI system 202 model, a model of a particular AI agent (e.g., one that covers or serves the user's home location rather than another that covers or serves the user's work location). Based on these pre-selections, which the AI client may communicate to the AI agent (e.g., upon or after the UE establishes a connection with the corresponding AP), the AI agent may determine whether it or another AI agent or even the operator-based AI system 202 should perform generative AI activities for the given user. The setting(s) may apply for pre-emptive content generation purposes and/or for actual user requests for generative AI content. In one example, a UE may be connected to the AP 206a, but where a user of that UE has a preset preference indicating that the AP 206b should be responsible for generating any AI content that is to be pushed or preemptively delivered to the UE. In this example, if the AI agent of the AP 206a or the operator-based AI system 202 decides to schedule a push of AI-generated content to the UE (e.g., local information or other relevant content), the AI agent of the AP 206a may, despite its capability to generate and deliver the content, nevertheless act in accordance with the user's preset preference and request or instruct the AI agent of the AP 206b to generate the content instead. Here, the content generated by the AI agent of the AP 206b may be sent to the AI agent of AP 206a or the operator-based AI system 202, which can then facilitate the delivery of the content to the UE.

In certain embodiments, the orchestrator-based AI system 202 and/or another network management system, may be configured to facilitate adaptive monitoring of AI-related resource usage and load. For instance, the orchestrator-based AI system 202 may, based on data received from the AI agent 216a regarding its resource usage, perform an analysis of the received data. The orchestrator-based AI system 202 may compare this data with historical data to determine whether the difference between the current and historical resource usage (e.g., differences in processing load, differences in response time, etc.) exceeds a predetermined threshold. If the orchestrator-based AI system 202 determines that the difference exceeds the threshold, the orchestrator-based AI system 202 may instruct the AI agent 216a and/or another network management system to obtain additional data related to the AI agent 216a's operations. This additional data may include information about the status of any ongoing processes associated with the AI agent 216a, such as error logs, processing statistics, and resource allocation details. The orchestrator-based AI system 202 may analyze this additional data to identify potential factors contributing to the above-threshold differences, which can inform the orchestrator-based AI system 202 on specific adjustments that can be made to improve or optimize the AI agent 216a's performance (e.g., reallocating resources, adjusting processing priorities, altering AI-generated content delivery scheduling criteria, altering AI-generated content delivery schedules, etc.). The orchestrator-based AI system 202 may then provide commands regarding such adjustments to the AI agent 216a and/or the network management system for implementation. In this manner, the orchestrator-based AI system 202 may limit its collection of additional data to instances where the initially received data indicates a suboptimal or abnormal condition. This approach reduces unnecessary data requests, thereby reduce or minimizing network traffic that could otherwise negatively impact network performance. If the orchestrator-based AI system 202 determines that the abnormal condition is resolved (i.e., the threshold is no longer exceeded), orchestrator-based AI system 202 may cease the collection of additional data from the AI agent 216a and/or other network management system, further improving or optimizing network performance and reducing unnecessary data traffic. The additional data can be used to analyze the cause of the poor or abnormal condition, thereby providing an improvement over existing adaptive AI agent management methods, resulting in a practical application that enhances overall AI agent performance monitoring.

It is to be understood and appreciated that, although FIG. 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various controllers, units, networks, devices, terminals, components, modules, engines, layers, systems, etc. may have been illustrated in FIG. 2A as separate controllers, units, networks, devices, terminals, components, modules, engines, layers, systems, etc., it will be appreciated that multiple controllers, units, networks, devices, terminals, components, modules, engines, layers, systems, etc. can be implemented as a single controller, unit, network, device, terminal, component, module, engine, layer, system, etc., or a single controller, unit, network, device, terminal, component, module, engine, layer, system, etc. can be implemented as multiple controllers, units, networks, devices, terminals, components, modules, engines, layers, systems, etc. Additionally, functions described as being performed by one controller, unit, network, device, terminal, component, module, engine, layer, system, etc. may be performed by multiple controllers, units, networks, devices, terminals, components, modules, engines, layers, systems, etc., or functions described as being performed by multiple controllers, units, networks, devices, terminals, components, modules, engines, layers, systems, etc. may be performed by a single controller, unit, network, device, terminal, component, module, engine, layer, system, etc.

FIG. 2B depicts an illustrative embodiment of a method 280 in accordance with various aspects described herein.

At 282, the method can include predicting that an AI client of a UE will submit a user-initiated AI-based request over a communication network that is operated by a first provider to an external AI system that is operated by a second provider. For example, the operator-based AI system 202 can, similar to that described above with respect to the system 200 of FIG. 2A, perform one or more operations that include predicting that an AI client of a UE will submit a user-initiated AI-based request over a communication network that is operated by a first provider to an external AI system that is operated by a second provider.

At 284, the method can include based on the predicting, causing an AI agent of an AP of an access network that is associated with the UE to obtain particular AI-based content that corresponds to the user-initiated AI-based request and to provide the particular AI-based content to the AI client in anticipation of the user-initiated AI-based request, thereby reducing network traffic in an uplink of the communication network. For example, the operator-based AI system 202 can, similar to that described above with respect to the system 200 of FIG. 2A, perform one or more operations that include based on the predicting, causing an AI agent of an AP of an access network that is associated with the UE to obtain particular AI-based content that corresponds to the user-initiated AI-based request and to provide the particular AI-based content to the AI client in anticipation of the user-initiated AI-based request, thereby reducing network traffic in an uplink of the communication network.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

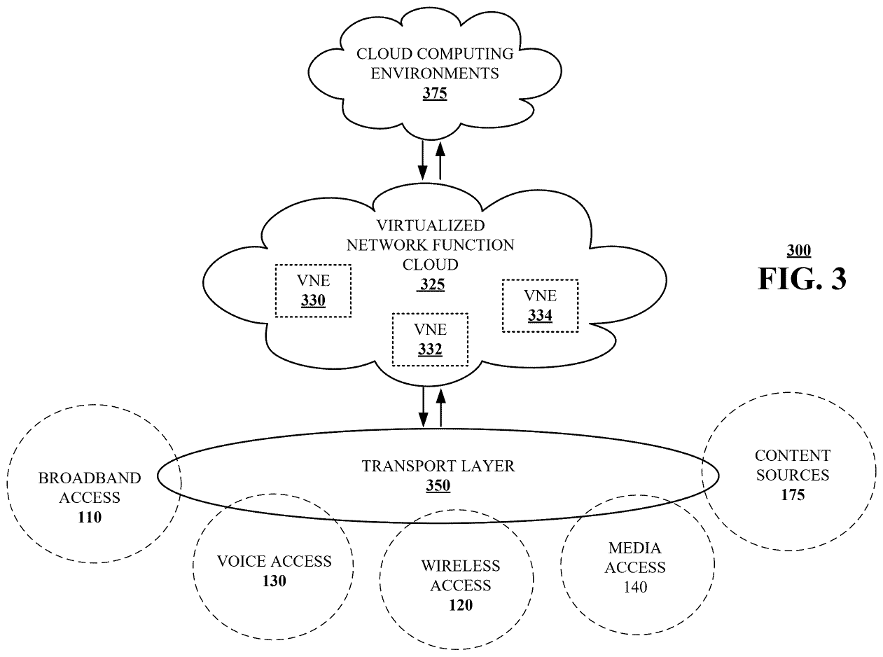

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 200, and method 280 presented in FIGS. 1, 2A, and 2B. For example, virtualized communications network 300 can facilitate, in whole or in part, dynamic delivery of AI-related content to AI agents/clients over a network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

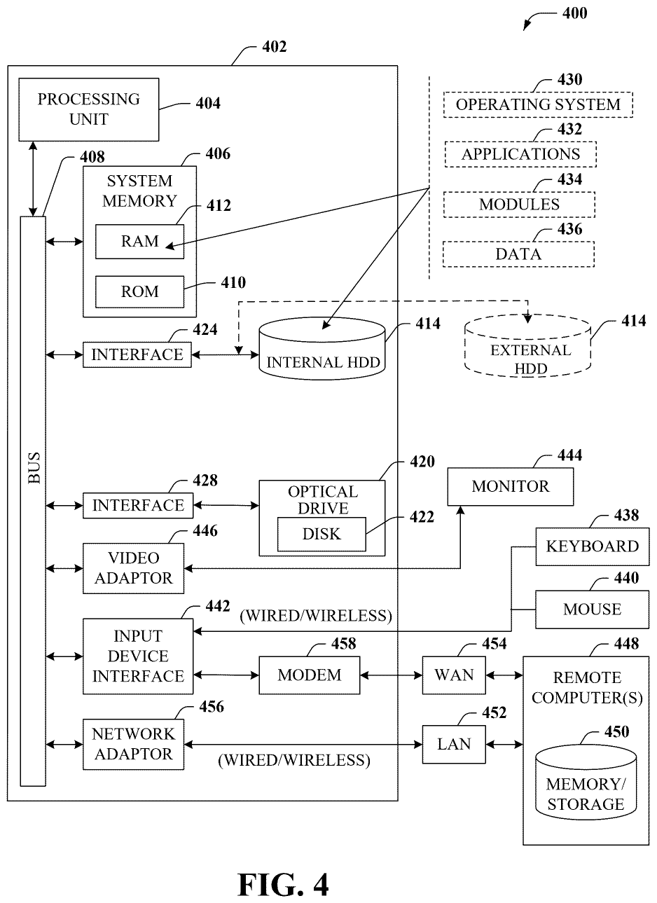

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, dynamic delivery of AI-related content to AI agents/clients over a network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high capacity optical media such as the DVD). The HDD 414, and optical disk drive 420 can be connected to the system bus 408 by a hard disk drive interface 424 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

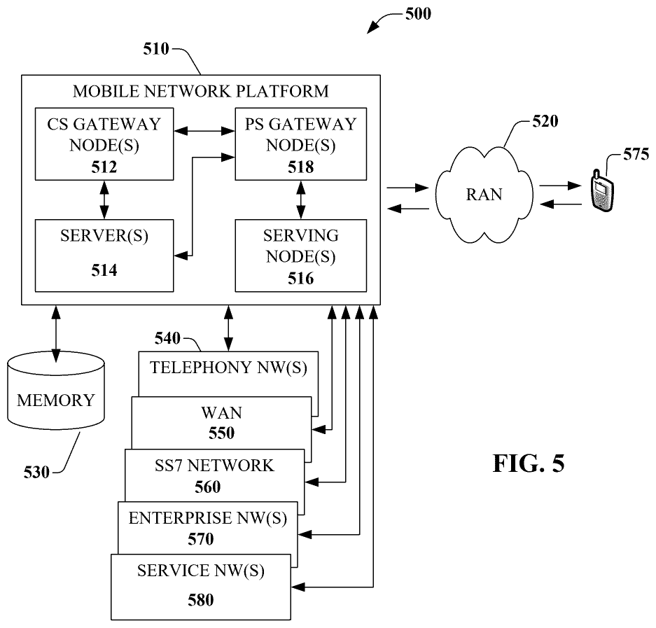

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, dynamic delivery of AI-related content to AI agents/clients over a network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

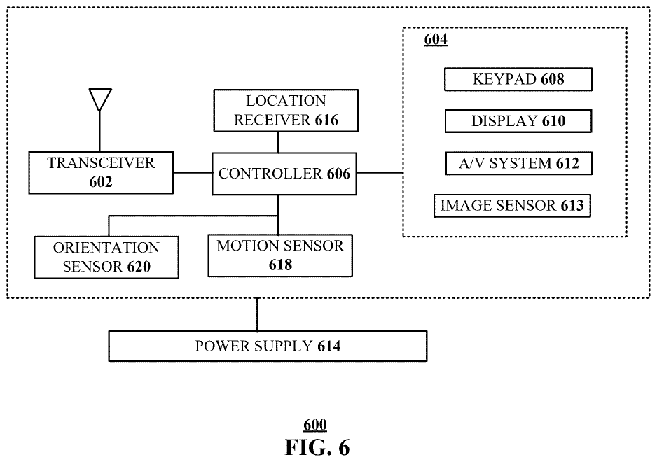

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, dynamic delivery of AI-related content to AI agents/clients over a network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth® . The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A system, comprising:
an operator-based artificial intelligence (AI) platform including a first AI model implemented in a mobility core; and
a plurality of AI agents including respective second AI models that are implemented in corresponding access points (APs) of an access network,
wherein one or more of the corresponding APs serve user equipment (UEs) that are within a coverage range thereof,
wherein the UEs include respective AI clients, and
wherein the operator-based AI platform is configured to orchestrate delivery of AI-based content to the plurality of AI agents, the respective AI clients, or a combination thereof based on one or more factors.

2. The system of claim 1, wherein the one or more factors relate to network conditions.

3. The system of claim 1, wherein the one or more factors relate to user profiles associated with the UEs.

4. The system of claim 1, wherein the one or more factors relate to determined user personalities associated with the UEs.

5. The system of claim 1, wherein the one or more factors relate to UE mobility.

6. The system of claim 1, wherein the one or more factors relate to UE priority.

7. The system of claim 1, wherein the AI-based content comprises respective content that is determined to be local to corresponding ones of the plurality of AI agents, corresponding ones of the respective AI clients, or a combination thereof.

8. The system of claim 1, wherein orchestration of delivery of the AI-based content involves:
predicting that a first AI client of the respective AI clients will submit a user-initiated AI-based request; and
based on the predicting, causing a first AI agent of the plurality of AI agents that is associated with the first AI client to perform one or more actions.

9. The system of claim 8, wherein the one or more actions include obtaining particular AI-based content that corresponds to the user-initiated AI-based request.

10. The system of claim 9, wherein the one or more actions include providing the particular AI-based content to the first AI client in anticipation of the user-initiated AI-based request.

11. The system of claim 10, wherein the providing is performed using a broadcast channel based on a UE priority associated with the first AI client satisfying a threshold.

12. The system of claim 10, wherein the providing is performed using a dedicated channel based on a UE priority associated with the first AI client satisfying a threshold.

13. The system of claim 1, wherein the one or more factors involve information obtained from an Operations Support System (OSS) associated with the mobility core.

14. A non-transitory machine-readable medium, comprising executable instructions that, when executed by a processing system including a processor, facilitate performance of operations, the operations comprising:
predicting that an artificial intelligence (AI) client of a user equipment (UE) will submit a user-initiated AI-based request; and
based on the predicting, causing an AI agent of an access point (AP) of an access network that is associated with the UE to obtain particular AI-based content that corresponds to the user-initiated AI-based request and to provide the particular AI-based content to the AI client in anticipation of the user-initiated AI-based request.

15. The non-transitory machine-readable medium of claim 14, wherein the predicting is based on location-related information, user profile data, user personality data, or a combination thereof.

16. The non-transitory machine-readable medium of claim 14, wherein providing of the particular AI-based content is performed in a manner that is based on network condition information, a priority level associated with the UE, or a combination thereof.

17. The non-transitory machine-readable medium of claim 16, wherein the manner relates to a schedule for delivery of the particular AI-based content, a type of channel that is used for the delivery, or a combination thereof.

18. A method, comprising:
predicting, by a processing system including a processor, that an artificial intelligence (AI) client of a user equipment (UE) will submit a user-initiated AI-based request over a communication network that is operated by a first provider to an external AI system that is operated by a second provider; and
based on the predicting, causing, by the processing system, an AI agent of an access point (AP) of an access network that is associated with the UE to obtain particular AI-based content that corresponds to the user-initiated AI-based request and to provide the particular AI-based content to the AI client in anticipation of the user-initiated AI-based request, thereby reducing network traffic in an uplink of the communication network.

19. The method of claim 18, wherein the predicting is based on location-related information, user profile data, user personality data, or a combination thereof.

20. The method of claim 18, wherein providing of the particular AI-based content is performed in a manner that is based on network condition information, a priority level associated with the UE, or a combination thereof.
